(19) United States
(12) Patent Application Publication
(10) Pub. No.: US 2008/0285274 A1
(43) Pub. Date: Nov. 20, 2008

(54) Panel light source for back-lit signs

(76) Inventor: Hae-Ryong Jung Jung, Arlington, VA (US)

Correspondence Address: HAE-RYONG JUNG, 2111 JEFFERSON DAVIS HWY., 119-N, ARLINGTON, VA, 22202, US

(21) Appl. No.: 12/153,208

(22) Filed: May 15, 2008

Related U.S. Application Data
(60) Provisional application No. 60/924,498, filed on May 17, 2007.
(60) Provisional application No. 60/924,753, filed on May 30, 2007.

(51) Int. Cl. F21V 21/00; G09F 13/18

(52) U.S. Cl. 362/240; 40/546

(57) ABSTRACT

Disclosed herein is an illuminated signboard using a plane light source in which edges of two light guide plates are cut in an inclined form, an opaque plate having high surface reflectivity is inserted between the two light guide plates to optically block the two light guide plates from each other, and the light guide plates and the opaque plate are combined to form a second lighting part. U-shaped frames including LEDs are connected to construct a frame housing and the second lighting part is combined with the frame housing. Light emitted from the LEDs and transmitted in the light guide plates is dispersed by a dispersing mechanism formed on the backsides of the light guide plates using paint, print ink or engraving to transmit the light guide plates and graphics or natural color pictures formed on transparent plates attached to the outer sides of the light guide plates so as to illuminate the graphics or the natural color pictures.

### BACKGROUND OF THE INVENTION

1. Field of the Invention

The present invention relates to an illuminated signboard using a plane light source, and more particularly, to an illuminated signboard using a plane light source in which light emitting diodes (LEDs) are arranged at the edges of a transparent light guide plate and light emitted from the LEDs is effectively inputted to the light guide plate, transmitted according to repeated total reflection thereof, dispersed when colliding with a rough face or meeting the boundary of a reflecting face of the light guide plate and an alien material coated on the reflecting face and radiated in various directions so as to be used as a single light source.

2. Background of the Related Art

The principle of edge light is applied to a monitor light of a computer or various displays used in general stores, and edge lights have specific structures according to their purposes and uses and are used for various displays.

For example, the Applicant proposed an edge lit display device disclosed in Korean Patent No. 168711. The edge lit display device includes a fluorescent lamp held by a lamp holder, a transparent display panel having first and second flat faces and a pipe type fixing housing having a mirror-like inner wall. Free edges of the display panel are cut in an inclined form, a sign made of a pressure-sensitive material is attached to the second flat face, and the lamp holder which is made of a high shock-resistant transparent plastic material is firmly combined with a linear cut edge of the display panel. Openings at both ends of the fixing housing are closed with caps and a vertically extended opening connected to the linear cut edge of the display panel is formed at the fixing housing.

In addition, the Applicant proposed an edge lit display system disclosed in Korean Patent No. 787759, which has a three-dimensional structure composed of a plurality of light guide plates such that the display system can be seen in various directions. A black plate is attached to the backside of a transparent light guide to block illuminating components other than graphics so as to achieve visual effect for observing the graphics and set off luminous graphics on the ground of the black plate.

To achieve this innovative edge lit system, a plurality of light sources or light source groups are arranged in close proximity to two bent edges of light guide plates to form a single three-dimensional structure. Graphics are formed on the inner walls or outer walls of the light guide plates and multiple edge lit display systems are hung from the ceiling or mounted on the wall or a horizontal plane such that the edge lit display systems are used as low-power decorations or lighting apparatus advertisement media.

Furthermore, the plurality of light sources or light source groups have different colors such that lights with various wavelengths interfere in the light guide plates to achieve beautiful visual effect.

However, the aforementioned edge lit display apparatus and the edge lit display system include glow lamps or tube type light sources and their backsides are irradiated to illuminate graphics formed thereon. Accordingly, a distance between the light sources and the graphics is considerably increased in order to obtain uniform brightness of the faces of the display apparatus and the display system on which the graphics are formed. This increases the volumes and weights of the edge lit display apparatus and the edge lit display system and requires considerable costs for manufacturing, installing and maintaining the edge lit display apparatus and the edge lit display system.

### SUMMARY OF THE INVENTION

Accordingly, the present invention has been made in view of the above-mentioned problems occurring in the prior art, and it is a primary object of the present invention to provide an illuminated signboard using a plane light source, which is manufactured according to the principle of edge light using LEDs, easily installed and maintained, requires low maintenance expenses, has high performance and replaces a conventional backlight signboard such as a dark light or a heavy light box manufactured using glow lamps or tube type light sources such as fluorescent lamps.

To accomplish the above object of the present invention, according to the present invention, there is provided an illuminated signboard using a plane light source in which an opaque plate having a high surface reflectivity is inserted between two flat light guide plates and the light guide plates and the opaque plate are joined to each other by means of a plurality of screws to form a single plate type secondary light source. U-shaped frames are combined with four sides of the plate type secondary light source such that the plate type secondary light source is surrounded by a frame housing. Transparent plates including graphics or natural color pictures are attached to the exposed outer side of the plate type secondary light source. PCBs and LEDs mounted on the surface of the PCBs are mounted in the frame housing such that light emitted from the LEDs is inputted to inclined edges of the light guide plates and transmitted in the light guide plates according to repeated total reflection thereof. The light transmitted in the light guide plates according to the repeated total reflection thereof is dispersed on painted faces and engraved rough faces formed on the inner sides of the light guide plates, which face the opaque plate interposed between the light guide plates. Then, the dispersed light is radiated in various directions and some of the dispersed light transmits the light guide plates and the transparent plates including the graphics and is seen by people. Accordingly, the illuminated signboard using a plane light source is thin and light, has brightness higher than a conventional light box, beautiful more than the conventional light box, is easily manufactured and maintained, and has additional functions such as color mixing and dynamic variation in illumination.

The illuminated signboard using a plane light source according to the present invention can replace various signboards including small indoor hanging signboards, conventional light boxes and even outdoor large illuminated signboards with the development of production technology of LEDs whose brightness increases and production cost decreases day by day. Furthermore, the illuminated signboard according to the present invention can reduce power consumption and remarkably decrease the manufacturing cost, installation cost and maintenance expenses.

Moreover, LEDs emitting lights in various colors can be combined to produce an illuminated signboard having much more beautiful colors so as to city beautification. In addition, the illuminated signboard can be combined with a clockwork device so as to be used as an illuminated timepiece.

### BRIEF DESCRIPTION OF THE DRAWINGS

The above and other objects, features and advantages of the present invention will be apparent from the following detailed description of the preferred embodiments of the invention in conjunction with the accompanying drawings, in which:

FIG. 1A is a cross-sectional view of an illuminated signboard according to an embodiment of the present invention;

FIG. 1B is an enlarged cross-sectional view of a portion of FIG. 1A;

FIG. 2A illustrates a configuration of a plane secondary light source in which painted faces are formed on the inner sides of light guide plates according to the present invention;

FIG. 2B illustrates a configuration of a plane secondary light source in which engraved rough faces are formed on the inner sides of the light guide plates according to the present invention;

FIG. 3 illustrates a combination of the plane secondary light source with a frame housing;

FIG. 4A is a cross-sectional view of an illuminated signboard having circular light guide plates according to another embodiment of the present invention;

FIG. 4B is a front view of the illuminated signboard having the circular light guide plates according to another embodiment of the present invention;

FIG. 5A is a front view of an illuminated signboard functioning as a timepiece;

FIG. 5B is a cross-sectional view of the illuminated signboard illustrated in FIG. 5A; and

FIG. 5C is an enlarged view of a portion of FIG. 5A.

### DETAILED DESCRIPTION OF THE PREFERRED EMBODIMENT

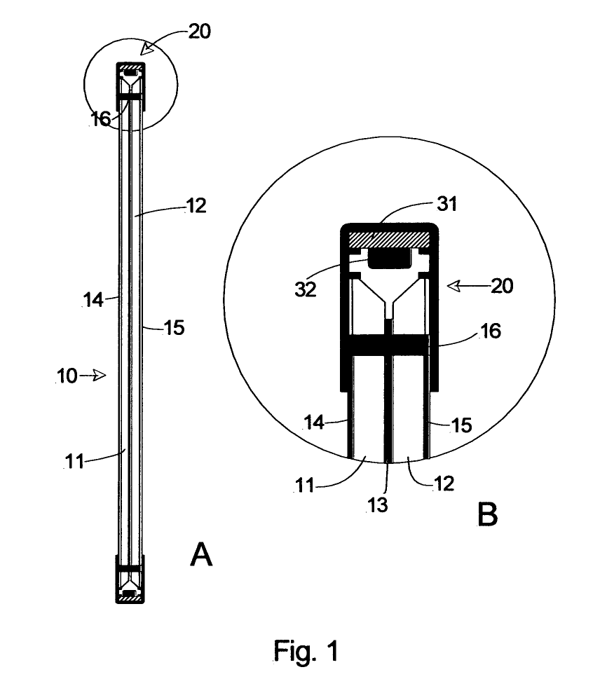

FIGS. 1, 2 and 3 illustrate a configuration of an illuminated signboard according to an embodiment of the present invention. Referring to FIGS. 1, 2 and 3, an opaque plate 13 having a high surface reflectivity is inserted between two flat light guide plates 11 and 12 and the light guide plates 11 and 12 and the opaque plate 13 are joined to each other by means of a plurality of screws 16 to form a single plate type secondary light source 10.

U-shaped frames 21, 22, 23 and 24 are combined with four sides of the plate type secondary light source 10 such that the plate type secondary light source 10 is surrounded by a frame housing 20. Transparent plates 14 and 15 including graphics or natural color pictures are attached to the exposed outer side of the plate type secondary light source 10.

PCBs 31 and LEDs 32 mounted on the surface of the PCBs 31 are mounted in the frame housing 20 such that light emitted from the LEDs 32 is inputted to inclined edges of the light guide plates 11 and 12 and transmitted in the light guide plates 11 and 12 according to repeated total reflection thereof.

The light transmitted in the light guide plates according to the repeated total reflection thereof is dispersed on painted faces 110 and engraved rough faces 111 formed on the inner sides of the light guide plates 11 and 12, which face the opaque plate 13 interposed between the light guide plates 11 and 12. Then, the dispersed light is radiated in various directions and some of the dispersed light transmits the light guide plates 11 and 12 and the transparent plates 14 and 15 including the graphics and is seen by people.

In the illuminated signboard using a plane light source constructed as above, light emitted from the LEDs 32 fixed onto the surfaces of the PCBs 31 mounted in the frame housing 20 is inputted to the inclined edges of the light guide plates 11 and 12 and transmitted in the light guide plates 11 and 12 which form the plate type secondary light source 10 according to repeated total reflection thereof.

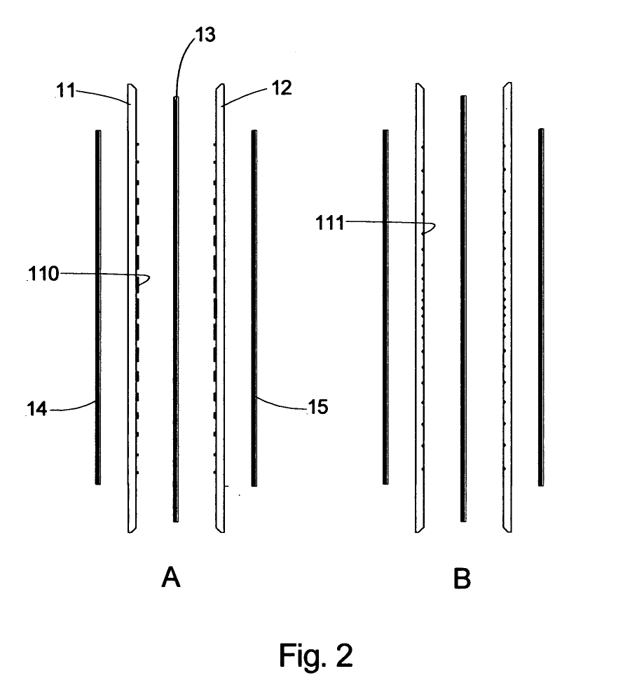

The light transmitted in the light guide plates 11 and 12 according to the repeated total reflection thereof is dispersed in various directions on the painted faces 110, as illustrated in FIG. 2A, which are formed by coating paint or printing ink on the inner sides of the light guide plates 11 and 12, or on the engraved rough faces 111 formed on the inner sides of the light guide plates 11 and 12, as illustrated in FIG. 2B.

Some of the dispersed light passes through the light guide plates 11 and 12 forming the plate type secondary light source 10 and the transparent plates 14 and 15 including graphics, attached to the secondary light source 10, and is seen by people located on both sides of the illuminated signboard.

The physical structure of the plate type secondary light source 10 in which the light emitted from the LEDs 32 is transmitted in the light guide plates 11 and 12 and dispersed is achieved by inserting the opaque plate 13 having a high surface reflectivity between the light guide plates 11 and 12 and combining the three plates 11, 12 and 13 using the plurality of screws 16, as illustrated in FIGS. 1A and 1B.

The opaque plate 13 optically shields illuminated graphics displayed on the two transparent light guide plates 11 and 12 such that the illuminated graphics are not seen from the opposite directions. Furthermore, both sides of the opaque plate 13 having high reflectivity reflect light transmitted in the light guide plates 11 and 12 to the outside of the light guide plates 11 and 12 such that the light is seen by people.

To disperse the light emitted from the LEDs 32 located at the edges of the light guide plates 11 and 12 and transmitted in the light guide plates 11 and 12 to obtain planar light, a device and consideration for controlling a degree of dispersion to maintain the brightness of the planar light uniform are required.

That is, to make the luminous intensity of the plate type secondary light source 10 uniform, it is required to increase the number of chances of dispersion of the light emitted from the LEDs 32 and transmitted in the light guide plates 11 and 12 as the distance between the transmitted light and the LEDs 32 increases to obtain uniform luminous intensity of the light guide plates 11 and 12 because the energy of the light decreases whenever the light is dispersed on the painted surfaces 110 or the engraved rough faces 111 and becomes weak as the distance between the light and the LEDs 32 increases.

To achieve this, the painted faces 110 or the engraved rough faces 111 are formed on the inner sides of the light guide plates 11 and 12 in such a manner that the width of painted portions or engraved portions increases and a distance between neighboring painted portions or neighboring engraved portions decreases as the painted portions and the engraved portions become distant from the LEDs 32, as illustrated in FIGS. 2A and 2B.

When the LEDs 32 are mounted only in the U-shape frames 21 and 22 combined with the top and bottom of the plate type secondary light source 10, there is no limit in the horizontal length of the plate type secondary light source 10 although the vertical length of the plate type secondary light source 10 is restricted in order to maintain uniform luminous intensity of the LEDs 32 of the plate type secondary light source 10. Accordingly, the present invention is most suitable for a two-sided display or a two-sided rectangular illuminated signboard hung from the ceiling.

The transparent plates 14 and 15 including graphics or natural color pictures, which are attached to the outer sides of the plate type secondary light source 10 are illuminated by the light transmitted and dispersed in the light guide plates 11 and 12.

When graphics are formed using opaque paint or an opaque film and attached to the surfaces of the transparent plates 14 and 15 adhering to the outer sides of the light guide plates 11 and 12, the graphics are illuminated according to light passing through portions which are not shielded by the opaque paint or the opaque film.

People can see the opaque graphics attached to the transparent plates 14 and 15, which are illuminated in a color of the wavelength of light emitted from the LEDs 32, more clearly.

When natural color pictures are printed on the transparent plates 14 and 15, a light dispersing layer is formed of semi-transparent white paint as the background of the natural color pictures, and then the natural color pictures are printed on the background. This improves color reproduction effect.

Illuminated graphics in a monotonous background color or illuminated natural color pictures can be seen according to which graphics or pictures are produced on the transparent plates 14 and 15 through various techniques. The transparent plates 14 and 15 including the graphics can be easily changed at any time.

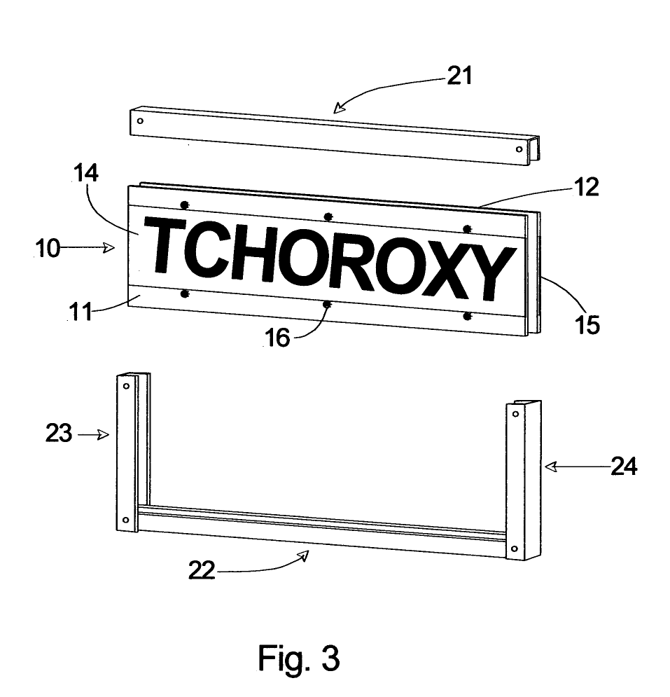

Referring to FIG. 3, the U-shaped frames 22, 23 and 24 respectively corresponding to the bottom and both sides of the plate type secondary light source 10 are assembled, the plate type secondary light source 10 is inserted into the assembled U-shaped frames 22, 23 and 24, and then the U-shaped frame 21 is combined with the top edge of the plate type secondary light source 10 to accomplish a secure plane light source. In addition, the transparent plates 14 and 15 including graphics or natural color pictures are attached to the plate type secondary light source 10 to accomplish a signboard or a display.

When only one side of the plane light source is needed, only one of the light guide plates 11 and 12 is combined with an inexpensive plate that has the same thickness, size and shape as those of the light guide plate and is made of a material different from the light guide plate using the plurality of screws 16 to obtain a uni-sided plane light source having high mechanical strength. In this case, the components used for the both-sided plane light source can be used, and thus new components are not required.

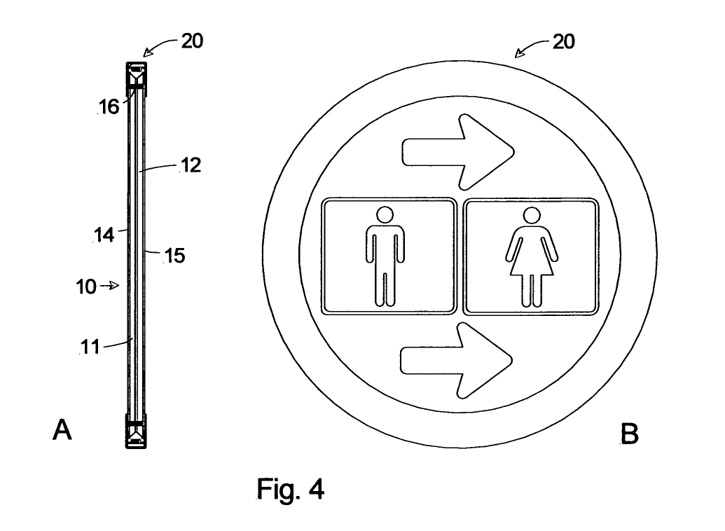

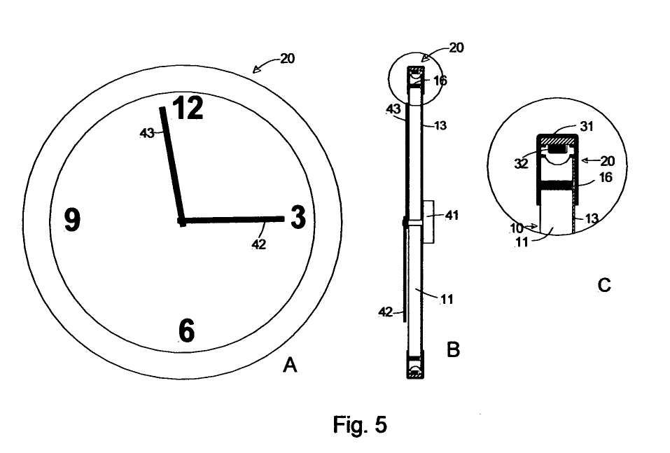

Furthermore, when the PCBs 31 are flexible and thin and have a tape-shaped and the LEDs 32 are arranged in a line on the PCB 31s, a curved plate type light source can be fabricated to obtain a curved illuminated signboard such as a two-sided circular illuminated signboard or an oval signboard, as illustrated in FIG. 4.

Moreover, a clockwork device 41, an hour hand 42 and a minute hand 43 are combined with the circular illuminated signboard and appropriate graphics are formed on the backside of the light guide plate 11 using engraving, paint or ink such that people can read time. In this case, the circular illuminated signboard functions as an illuminated timepiece.

Furthermore, when at least two LEDs 32 different in color from each other are arranged in an appropriate order and used as a primary light source, the different colors interfere in the light guide plates to produce beautiful color mixture. Moreover, when a switch is used to sequentially turn on/off LEDs in a predetermined order, visual effect which produces dynamic variations in the luminous intensity and color of the plane light source can be obtained.

While the present invention has been described with reference to the particular illustrative embodiments, it is not to be restricted by the embodiments but only by the appended claims. It is to be appreciated that those skilled in the art can change or modify the embodiments without departing from the scope and spirit of the present invention.

What is claimed is:

1. An illuminated signboard using a plane light source, comprising:
a plate type secondary light source 10 manufactured in such a manner that an opaque plate 13 having high surface reflectivity is inserted between two transparent light guide plates 11 and 12 having edges cut in an inclined form and the light guide plates and the opaque plate are joined to each other by means of a plurality of screws 16; and
a frame housing 20 consisting of U-shaped frames 21, 22, 23 and 24 having a plurality of LEDs 32 mounted on PCBs 31 attached to the inner faces thereof,
wherein the U-shaped frames 21 and 22 in which the LEDs 32 are mounted are respectively combined with the top and bottom of the plate type secondary light source 10 and the U-shaped frames 23 and 24 having no LED mounted therein are respectively combined with the left and right sides of the plate type secondary light source 10 such that the plate type secondary light source 10 is surrounded by the frame housing 20, and transparent graphic plates 14 and 15 including graphics or natural color pictures are attached to the outer sides of the light guide plates 11 and 12 of the plate type secondary light source 10.

2. The illuminated signboard using a plane light source according to claim 1, wherein a painted face 110 is formed on the inner side of each of the light guide plates 11 and 12, which faces the opaque plate, in such a manner that the width of painted portions of the painted face increases and a distance between neighboring painted portions decreases as the painted portions become distant from the LEDs and closer to the center of the light guide plate in the horizontal direction, and the transparent plates 14 and 15 including the graphics or natural color pictures are attached to the outer sides of the light guide plates 11 and 12.

3. The illuminated signboard using a plane light source according to claim 1, wherein an engraved rough face 111 is formed on the inner side of each of the light guide plates 11 and 12, which faces the opaque plate 13, in such a manner that a distance between neighboring engraved portions of the engraved rough face decreases as engraved portions become distant from the LEDs and closer to the center of the light guide plate in the horizontal direction.

4. The illuminated signboard using a plane light source according to claim 1, wherein the light guide plates 11 and 12 are curved, the edges of the light guide plates are cut in an inclined form, the plurality of LEDs 32 are mounted on a flexible thin tape-shaped PCB 31 in a line, and the transparent plates 14 and 15 including graphics or natural color pictures are respectively attached to the outer sides of the light guide plates 11 and 12.
